(19) United States
(12) Patent Application Publication
(10) Pub. No.: US 2005/0183461 A1
(43) Pub. Date: Aug. 25, 2005

(54) Method for producing an optical component

(75) Inventors: Bodo Kuhn, Hanau/Main (DE); Igor Radosevic, Offenbach (DE); Bruno Uebbing, Alzenau (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: Heraeus Quarzglas GmbH & Co. KG, Hanau (DE)

(21) Appl. No.: 11/063,956

(22) Filed: Feb. 22, 2005

(30) Foreign Application Priority Data
Feb. 25, 2004 (DE) 10 2004 009 557.9

(51) Int. Cl. C03B 37/018

(52) U.S. Cl. 65/422; 65/424; 65/426

(57) ABSTRACT

A method for producing an optical component for transmitting ultraviolet radiation of a wavelength of 250 nm and shorter, wherein the component is made from a cylindrical quartz glass blank having a mean OH content of more than 50 wt ppm, which is subjected to a first annealing treatment for eliminating stress birefringence, characterized in that the quartz glass blank is subjected to a second annealing treatment which comprises heating up and holding the quartz glass blank at a low annealing temperature ranging from 350° C. to 800° C. and for an annealing period of more than 1 hour, with the proviso that a quartz glass blank is used in which in a direction perpendicular to the cylindrical longitudinal axis the deviation from the mean OH content is not more than 20 wt ppm.

The present invention relates to a method for producing an optical component for the transmission of ultraviolet radiation of a wavelength of 250 nm and shorter, wherein the component is made from a cylindrical quartz glass blank having a mean OH content of more than 50 wt ppm, which is subjected for a first annealing treatment for eliminating stress birefringence.

Optical components made from quartz glass are used for transmitting high-energy ultraviolet laser radiation, for instance in the form of exposure optics in microlithography devices for producing large-scale integrated circuits in semiconductor chips. The exposure systems of modern microlithography devices are equipped with excimer lasers emitting high-energy pulsed UV radiation of a wavelength of 248 nm (KrF laser) or of 193 nm (ArF laser).

In optical components made from synthetic quartz glass, short-wave UV radiation may produce defects resulting in absorptions in the ultraviolet wavelength range. Of particular interest is the behavior of quartz glass with respect to short-wave UV radiation as is emitted by UV excimer lasers in microlithography devices. Type and extent of such a defect formation depend on the respective irradiation conditions and are determined by the quality of the used quartz glass, which is essentially determined by structural characteristics, such as density and homogeneity, and by the chemical composition.

The literature describes a great number of damage patterns in the case of which an increase in absorption will be observed upon continued UV irradiation. The induced absorption may, for instance, rise linearly, or saturation is reached following an initial rise. Furthermore, it has been observed that an initially registered absorption band will first disappear after a few minutes after the laser has been switched off, but it will rapidly regain the level once reached after renewed irradiation. This damage pattern is designated as a “rapid damage process” (RDP). The background for this is that network defects are first saturated by reaction with hydrogen atoms existing in the quartz glass and can thus not be noticed optically (as absorption). The stability of these bonds, however, is low, so that they may break up when the component is exposed to UV radiation.

A damage behavior known as “compaction” occurs during or after laser irradiation with a high energy density and is expressed in a local density increase in the glass in the irradiated volume, which in turn leads to a locally inhomogeneous rise in the refractive index and thus to a deterioration of the imaging characteristics of the optical component.

Depending on the type of quartz glass, an opposite effect may occur just as well when an optical component consisting of the quartz glass is subjected to laser radiation of a low energy density, but high pulse number. Under these conditions a so-called “decompaction” is observed (also called “rarefaction” in the English literature), which is accompanied by a local reduction of the refractive index. In this process the irradiation also leads to a local density change in the irradiated volume and to an accompanying deterioration of the imaging characteristics.

Compaction and decompaction are thus defects which do not necessarily express themselves in an increase in the radiation-induced absorption, but may limit the life-time of an optical component. The influence of the OH content on compaction and decompaction in UV irradiation was investigated by B. Kühn, B. Uebbing, M. Stamminger, I. Radosevic, S. Kaiser in ,,Compaction versus expansion behavior related to the OH-content of synthetic fused silica under prolonged UV-laser irradiation”, J. Non-Cryst. Solids, No. 330 (2003), pp. 23-32.

In microlithographic projection exposure systems the demand is in general made that a light distribution provided in the area of a pupil plane of the exposure system should be transmitted as homogeneously as possible and in an angle-maintaining manner into a pupil plane of the projection lens conjugated relative to the pupil plane of the exposure system. Each change in the angular spectrum that is created in the optical path leads to a distortion of the intensity distribution in the lens pupil, which leads to an asymmetrical irradiation and thus to a deterioration of the imaging performance.

In this context birefringence plays an important role because it impairs the imaging fidelity of optical components of quartz glass. Stress birefringence in the quartz glass is created during inhomogeneous cooling of the blank used for the optical component to be produced.

The light propagation in birefringent quartz glass is characterized in that the incident light beam is (virtually) decomposed into two partial beams that are perpendicular to one another and polarized in the direction of propagation, and whose polarization directions extend in parallel and perpendicular to the optical axis in the direction of load (compressive stress or tensile stress), and which have different propagation speeds. The axis of the faster propagation speed will also be designated as the “fast axis of birefringence” in the following. It has been found that the faster axis of the birefringence after standard annealing of the blank, as will be described further below in more detail, shows a rather tangential extension around the cylindrical longitudinal axis.

A standard annealing program for removing mechanical stresses in the blank and for achieving a homogeneous distribution of the fictive temperature is suggested in EP 0 401 845 A2. The blank is held at a temperature of about 1100° C. for 50 hours and is then cooled in a slow cooling step at a cooling rate of 2° C./h, at first to 900° C., before the annealing furnace is switched off, so that a cooling of the quartz glass blank to room temperature, which corresponds to the natural cooling of the furnace, takes place in the closed furnace in a subsequent step. Stress birefringence of the blank can be reduced by means of such annealing treatments.

It has been found in EP 1 114 802 A1 that size and distribution of the stress birefringence of a quartz glass blank can be adjusted by an annealing temperature in the temperature range between 1500° C. and 1800° C., and preferably between 1550° C. and 1650° C.

It should be noted that due to long-term heating treatments at a high temperature the out-diffusion of components, especially of OH groups and hydrogen, may cause local changes in the chemical composition and a concentration gradient from near-surface areas of the blank to the inside. The inhomogeneity caused thereby acts again on the radial profile of the refractive index in the component to be produced. Moreover, impurities may diffuse into the quartz glass during treatment. Sodium, nickel and copper should here be particularly mentioned as harmful substances. Therefore, stress birefringence and chemical homogeneity of the quartz glass component can often not be optimized independently of one another, or only at the expense of other properties, such as radiation resistance.

It is therefore the object of the present invention to indicate a method for producing a cylindrical optical component which is characterized by little change in density and refractive index during irradiation with UV radiation and is thus characterized by an improved damage behavior with respect to UV radiation, and which is optimized, on the other hand, with respect to the remaining stress birefringence.

Starting from the above-described method, this object is achieved according to the invention in that the quartz glass blank is subjected to a second annealing treatment which comprises heating up and holding the quartz glass blank at a low annealing temperature ranging from 350° C. to 800° C. and for an annealing period of more than 1 hour, with the proviso that a quartz glass blank is used in which in a direction perpendicular to the cylindrical longitudinal axis the deviation from the mean OH content is not more than 20 wt ppm.

After the finishing treatment the optical component is made from the quartz glass blank, and, as a rule, material must still be removed for adjusting the geometrical shape and a high surface quality. In this respect the quartz glass blank has a contour area which corresponds to the outer contour of the optical component to be made, and an overdimension which surrounds said contour area, but which is kept as small as possible for economic reasons.

After its last hot treatment, e.g. a deformation process, the quartz glass blank is always subjected to an annealing process to reduce stresses created by rapid cooling after the hot treatment and thus for improving the mechanical stability and optical characteristics (refractive index distribution and stress birefringence). Typical annealing programs for quartz glass blanks are designed for holding them at a temperature above 1100° C., and a slow cooling to a temperature range around 800° C.-1000° C. takes place in a subsequent step, as described in the above-mentioned EP 0 401 845 A1.

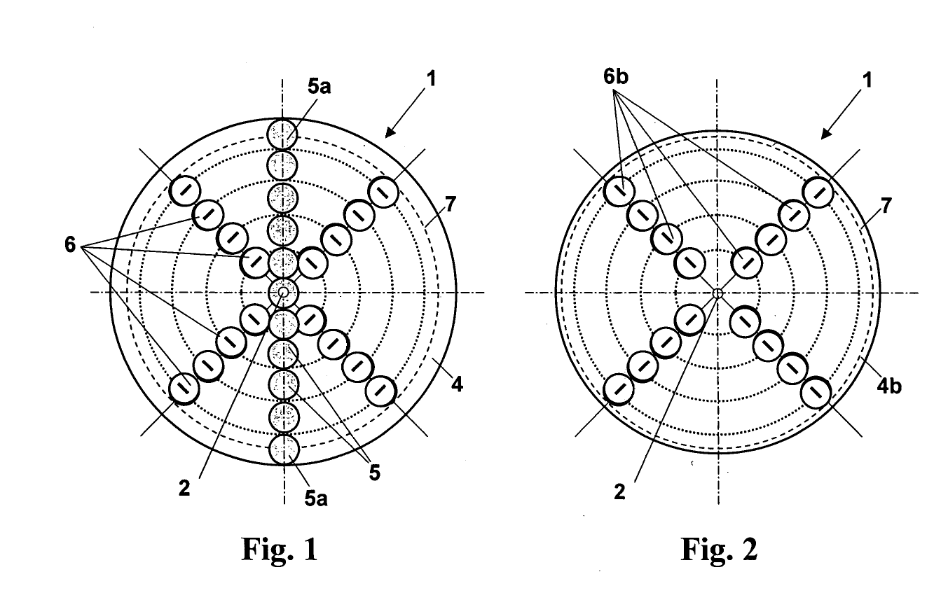

The two properties explained in the following, from which the invention starts, are typical of the cylindrical quartz glass blanks annealed in this way:
On the one hand, it has been found that after cooling of the cylindrical blanks, possibly due to the cylindrical symmetry thereof, profiles of the fast axis of birefringence have been established that are predominantly of a tangential nature. This means that at measurement points in a measurement plane extending in a direction perpendicular to the cylindrical longitudinal axis of the blank, essentially stress birefringence profiles are determined in which the fast axis of birefringence has a rather tangential extension around the cylindrical longitudinal axis. Such a distribution of the fast axis of stress birefringence is schematically shown in FIG. 1.
On the other hand, it is known that quartz glass rapidly cooled from the temperature range between 1000° C. and 1500° C. has a lower specific volume and thus a higher specific density than quartz glass cooled at a slow rate. According to “R. Brückner, Silicon Dioxide; Encyclopedia of Applied Physics, Vol. 18 (1997), pp. 101-131”, this effect is due to an anomaly of synthetic quartz glass in the case of which the evolution of the specific volume in the range between 1000° C. and 1500° C. has a negative temperature coefficient, i.e., the specific volume of quartz glass increases in this temperature range with a decreasing temperature. During annealing of quartz glass at a low temperature this is apparently accompanied by an increase in the specific (molar) volume with the annealing duration, the increase in volume being all the more pronounced the higher the annealing temperature is.

It has been found that these two typical properties of the annealed quartz glass blank are influenced by the second annealing treatment at the comparatively low temperature in the range between 350° C. and 800° C., resulting in the surprising effect which will be explained in the following:
Due to the second annealing treatment the spatial distribution of the fast axis of birefringence is changed from a rather tangential orientation to a rather radial orientation relative to the cylindrical longitudinal axis. Such a distribution of the fast axis of stress birefringence, which is schematically shown in FIG. 2, will also be called “stress birefringence of a radial-symmetric nature” in the following, and the process of re-orientating the angle will be designated as a “change in angular distribution”.

The stress birefringence of a tangential nature and also that of a radial-symmetric nature change the state of polarization and the wavefront of the light transmitted in the quartz glass blank, thereby producing aberration. However, as for the phase difference in the transmitted light, which is caused by the respective stress birefringence, opposite effects are found. This means that a phase difference in the transmitted light created in a quartz glass component due to stress birefringence of the one type can be compensated completely or in part by a subsequent light transmission in a quartz glass component exhibiting stress birefringence of the other type.

The optical components produced according to the method of the invention are therefore suited to compensate aberration of other optical components in the same optical path. Thanks to the compensation effect, a higher absolute value of stress birefringence can be tolerated in individual optical components.

The quartz glass blank is thus optimized with respect to the remaining stress birefringence, the method of the invention having the further advantage in comparison with the above-mentioned known method that due to the annealing treatment at a comparatively low temperature the chemical composition of the quartz glass component is hardly changed.
It has also been found that the annealing temperature at the comparatively low temperature has a distinct effect on the damage behavior of quartz glass with respect to UV radiation. Especially with this kind of quartz glass that is typically prone to decompaction, a surprisingly low decompaction (rarefaction) is observed after UV-light irradiation in comparison with the untreated quartz glass. This can be explained by the fact that the annealing treatment effects, on the whole, a relaxation of the glass structure and thus an increase in the specific volume of the quartz glass component, and this “anticipated” decompaction of the glass structure thereby counteracts local decompaction during UV irradiation. In this respect the aftertreatment also prevents or reduces radiation damage by “rarefaction”, so that the quartz glass component produced according to the invention is characterized by small local density and refractive-index changes upon irradiation with UV radiation.

The effect of the annealing treatment at the comparatively low annealing temperature can only be achieved within economically reasonable annealing times if use is made of a quartz glass blank that has an OH content of more than 50 wt ppm. The OH content facilitates relaxation of the glass structure that is needed for a change in, or reversal of, the angular distribution of the fast axis of stress birefringence and also for reducing decompaction.

Due to the preceding hot processes a lower OH content is normally obtained in the peripheral portion of the cylindrical quartz-glass blank than in the center of the blank. In the subsequent annealing treatment, the comparatively low OH content leads to stresses that impede the desired change in angular distribution.

A further imperative precondition for the success of the method according to the invention is therefore a homogeneous distribution of the OH group concentration. Of decisive importance is here the radial distribution of the OH groups in the quartz glass blank; the deviation from the mean OH content in a direction perpendicular to the cylindrical longitudinal axis of the blank must not be more than 20 wt ppm in the area of the contour of the optical component. Otherwise, a homogeneous relaxation of the glass structure over the whole contour area of the component cannot be achieved, and a reversal of the angular distribution is rendered difficult or prevented. In the case of a radial gradient in the OH concentration the distribution of the OH groups is ideally radial-symmetric about the cylindrical longitudinal axis.

The presence of a homogeneous radial distribution of the OH group concentrations in the quartz glass blank is ensured in that the OH contents are determined by spectroscopy over the thickness of the blank at several measurement points that are distributed in a uniform grid in a measurement plane extending in a direction perpendicular to the cylinder axis. According to the invention it must be ensured that none of the OH contents determined at the measurement points differs by more than 20 wt ppm from the mean value which follows from the individual measurements.

It has turned out to be of advantage when the annealing period lasts for at least 50 h.

With shorter annealing periods both the effect of the reversal of the angular distribution towards a radial-symmetric distribution relative to the cylindrical longitudinal axis and the effect of the “advance relaxation” of the glass structure for reducing decompaction are less pronounced.

However, it has here been found that the annealing duration is preferably 720 h at the most. In the case of annealing periods of more than 720 h the said effects are no longer enhanced significantly so that the method becomes more uneconomic due to the long process times, and the disadvantages prevail that are created by the out-diffusion of components and by an increasing contamination due to diffusing impurities.

It has turned out to be particularly advantageous when the quartz glass blank is annealed in a hydrogen-containing atmosphere.

It is known that hydrogen can have an advantageous effect on the radiation resistance of quartz glass to high-energy UV radiation, especially with respect to the long-term stability of quartz glass.

Furthermore, it has turned out to be advantageous when the quartz glass blank is annealed at a pressure between 10⁵ and 10⁶ Pa.

An increased pressure accelerates re-structuring and relaxation of the glass network and thus the change in the angular distribution of the fast axis of stress birefringence. During annealing in a hydrogen-containing atmosphere the doping process with hydrogen is also accelerated by the overpressure.

The annealing treatment advantageously comprises holding at a temperature of at least 500° C., with the proviso that the mean hydrogen content of the quartz glass blank is not changed by more than +/−20% (based on the initial hydrogen content) because of the treatment.

Annealing in the range between 500° C. and 800° C. effects, in particular, an accelerated reversal of the angular distribution towards a radial-symmetric distribution relative to the cylindrical longitudinal axis. On the other hand, however, this procedure is only preferred in cases where the atmosphere during annealing of the quartz glass blank has no hydrogen added, or at best in an amount corresponding to the partial pressure of hydrogen, which is needed for approximately maintaining the hydrogen initially contained in the quartz glass. A deviation of +/−20%, based on the initially contained hydrogen, is here acceptable. Additional doping of the quartz glass blank with hydrogen should be avoided for the following reason. Due to thermodynamic conditions Si—H groups are formed to a greater extent at the elevated temperatures (500° C.-800° C.) in the presence of hydrogen. These groups contribute to the above-explained RDP problem because upon irradiation with high-energy UV light a so-called E′ center and atomic hydrogen are formed from the Si—H group. The E′ center effects an enhanced absorption at a wavelength of 210 nm and is also negatively noticed in the adjoining UV wavelength range.

If the quartz glass is doped with hydrogen, the quartz glass blank is therefore preferably doped at a low temperature below 500° C., so that the formation of Si—H groups is reduced.

A modification of the method according to the invention has turned out to be particularly useful, wherein the quartz glass blank has an over-dimensioned outer contour of the optical component to be produced, and at least part of the overdimension is removed between the first and second temperature treatment.

It has been found that the quartz glass blank after the first annealing treatment has normally a gradient in its chemical composition in the area of the surface. In particular, the OH content and the hydrogen content are reduced in the near-surface regions. This is bound to lead to stresses in the subsequent second annealing process and to an inhomogeneous distribution of the fictive temperature of the quartz glass, which in turn has an effect on the relaxation of the glass network and particularly the angular distribution of the fast axis of stress birefringence and its change during the second annealing process. To avoid such a situation, the preferred modification of the method provides for a quartz glass blank which comprises the over-dimensioned contour of the optical component to be produced so that after the first annealing treatment the quartz glass blank can be controlled in its composition with respect to a gradient and the overdimension can be removed, if necessary, either completely or in part before the second annealing treatment. Under this aspect the overdimension in the area of the outer cylindrical surface of the blank is particularly harmful. A gradient in the composition between the inner region and the surface of the quartz glass blank is thereby eliminated or at least reduced before the second annealing treatment, and an impairment of the effects of the annealing treatment by internal stresses of the blank is thereby reduced, for while the blank prepared in this way is being annealed there are thus no stresses between the surface and the interior due to different glass compositions and fictive temperatures and thus no influence on the distribution of the angle of the fast axis of birefringence and thus on the polarization characteristics of the quartz glass blank.

On the other hand, it has turned out to be particularly advantageous when the quartz glass blank prior to the second annealing treatment has an over-dimensioned outer contour of the optical component to be produced, and the overdimension of the cylinder faces ranges from 1 mm to 5 mm.

The maintenance of an overdimension during the second annealing treatment has the advantage that a gradient which is only formed in the course of the annealing treatment in the composition between surface and interior of the blank can be removed subsequently, resulting in an optical component having a homogeneous composition. Under this aspect the overdimension is particularly useful in the area of the faces of the cylindrical blank.

Preferably, the mean OH content of the quartz glass blank prior to the temperature treatment is at least 450 wt ppm.

This variant of the method of the invention has turned out to be particularly advantageous with respect to the improvement of the decompaction behavior. It has been found that an increase in the specific volume of the quartz glass due to the second annealing treatment depends on the mean OH content of the quartz glass blank prior to the temperature treatment and is particularly pronounced at OH contents above 450 wt ppm, just like the tendency to decompaction.

A further improvement is achieved when the mean hydrogen concentration of the quartz glass blank after the temperature treatment is at least 3×10¹⁶ molecules/cm³.

The hydrogen content contributes to an improved resistance to radiation. The hydrogen is contained in the blank either in a concentration of at least 3×10¹⁶ molecules/cm³ already before the temperature treatment (attention must here be paid that during the temperature treatment the hydrogen concentration does not fall below the said lower limit due to the out-diffusion of hydrogen from the quartz glass blank), or the quartz glass blank is doped with hydrogen during temperature treatment to a concentration above the said minimum concentration.

Hence, the method of the invention permits a change in the distribution of the angle of the fast axis of birefringence, thereby substantially maintaining the chemical composition of the quartz glass and its properties, and also effects an improvement of the optical component to be produced with respect to the radiation resistance thereof in that it reduces the local decompaction of the quartz glass by UV irradiation by producing a previously decompacted structure.

The invention shall now be explained in more detail with reference to embodiments and a drawing which shows in detail in

FIG. 1 a top view on a measurement plane extending in a direction perpendicular to the cylindrical longitudinal axis of a quartz glass ingot before the second annealing treatment, in a schematic illustration;

FIG. 2 the top view of FIG. 1 after the second annealing treatment;

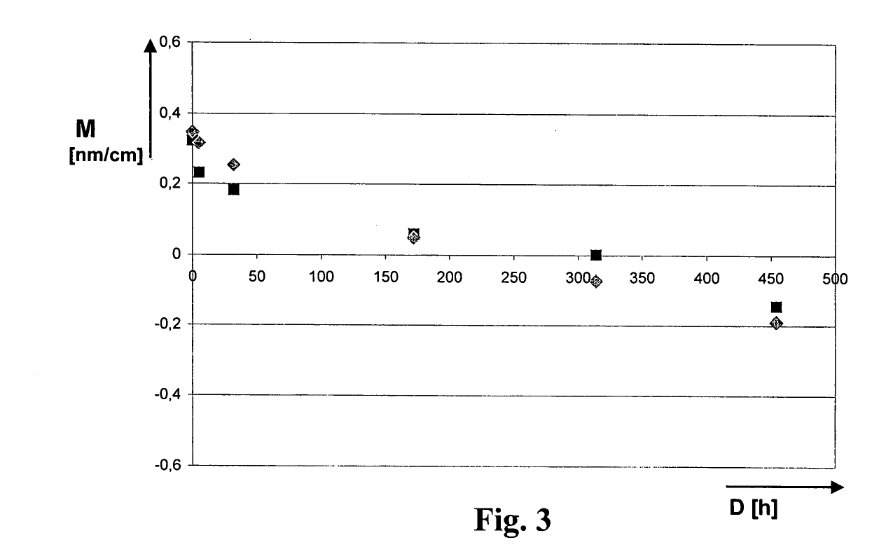

FIG. 3 a diagram on the degree of re-orientation of the angle of the fast axis of stress birefringence in dependence upon the annealing duration;

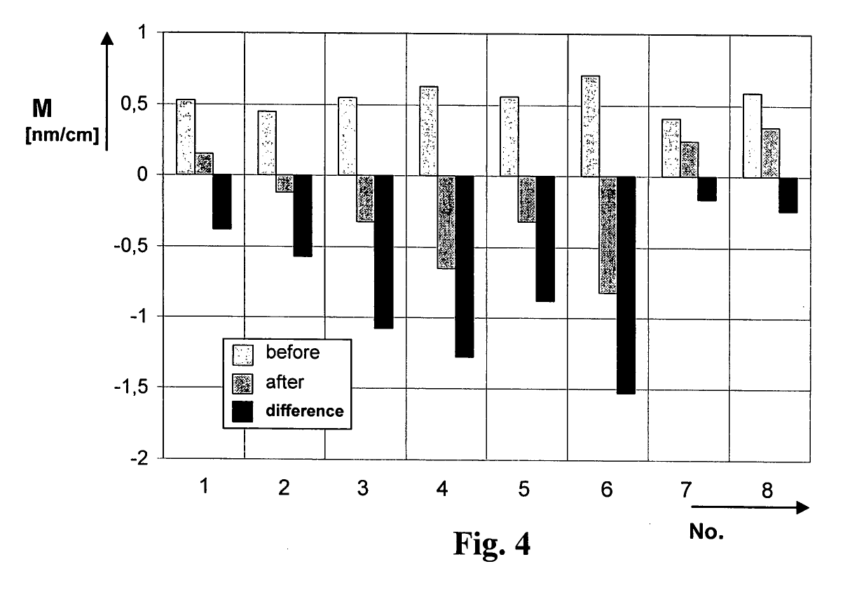

FIG. 4 a bar diagram showing the angular distribution of the fast axis of birefringence before and after the second annealing treatment and the mathematically determined difference; and

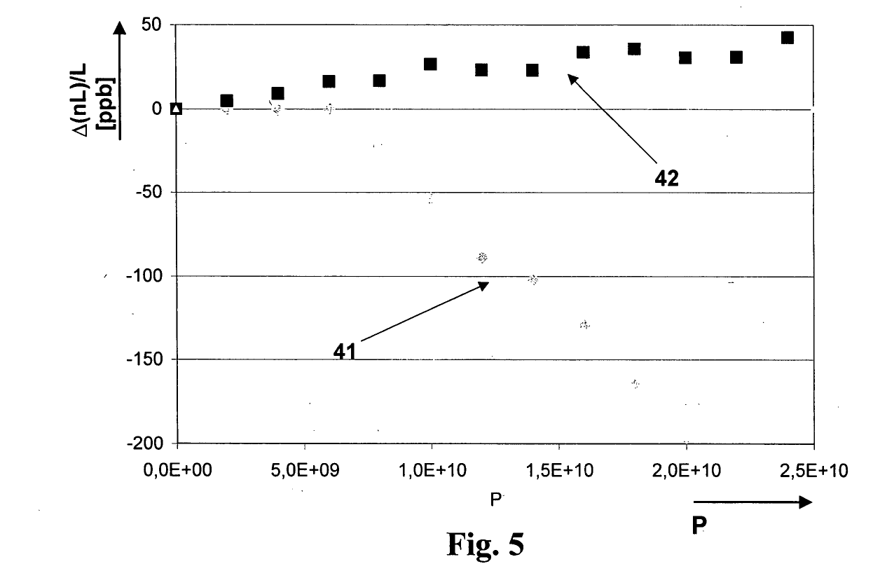

FIG. 5 a diagram for explaining the occurrence of compaction and decompaction with typical developments in differently treated measurement samples, in a schematic illustration.

### SAMPLE PREPARATION

Disk-shaped ingots of synthetic quartz glass were produced by flame hydrolysis of SiCl₄ on the basis of the known OVD (outer vapor deposition) method (soot method) and the VAD (vapor-phase axial deposition) method with direct vitrification of the SiO₂ particles produced. The quartz glass obtained according to the soot method is characterized by a mean OH content below about 300 wt ppm, and the quartz glass produced by direct vitrification has a comparatively high OH content above 400 wt ppm.

For reducing mechanical stresses and for decreasing birefringence the ingots were subjected to a first annealing treatment in which they were heated in air and at atmospheric pressure to 1130° C. and then cooled at a cooling rate of 1° C./h to a temperature of 900° C. After the furnace had been switched off, the samples cooled to room temperature in the closed furnace.

After grinding and etching of the surface, the following properties were each time measured on the cylindrical quartz glass ingots prepared in this way:
the mean hydrogen content,
the mean OH content and the maximum deviation from the mean OH content in a direction perpendicular to the cylinder axis,
the amplitude of stress birefringence at several measurement points evenly distributed over the ingot, and the respective orientation of the fast axis of stress birefringence,
the compaction and decompaction behavior upon irradiation with UV radiation.

Depending on the measured OH content and its distribution, part of the radial over-dimension was then removed from the quartz glass ingots, and these were then subjected to a second annealing treatment at a lower temperature, which will be described in more detail further below. Some of the above-mentioned characteristics were then measured again. The respective measuring methods shall be explained in more detail in the following:

Determination of the Hydrogen Content

The hydrogen content and its distribution in the ingots were determined by way of Raman measurements. The measuring method used is described in: Khotimchenko et al.: “Determining the Content of Hydrogen Dissolved in Quartz Glass Using the Methods of Raman Scattering and Mass Spectrometry” Zhurnal Prikladnoi Spektroskopii, Vol. 46, No. 6 (June 1987), pp. 987-991.

The mean hydrogen content of the ingots prior to the second annealing treatment was in the range between 2×10¹⁶ molecules/cm³ and 2×10¹⁷ molecules/cm³. The individual values are indicated in column 7 of Table 1.

Determination of the OH Content

Before the second annealing process the mean OH content and the maximum deviation from the mean OH content were determined on the ingots. On the basis of a measurement series, the OH content was determined by spectroscopy for each ingot, each time at eleven measurement points distributed over the radial cross-section (perpendicular to the cylindrical longitudinal axis of the ingots), as schematically shown in FIG. 1 with reference to points 5 and 5a. On the basis of the measurement series, the mean content of each ingot and the deviation therefrom were determined at each individual measurement point. The measuring spot in the determination of OH has a diameter of about 5 mm.

It has been found that after the first annealing treatment the OH contents determined at the respective peripheral points 5a were more than 20 wt ppm below the mean value that had been calculated in consideration of these peripheral points. Therefore, with the exception of test ingots 7 and 8, the previously existing overdimension, i.e. the radial portion 4 projecting beyond the outer contour 7 (FIG. 1) of the optical component, was removed to such an extent that the deviation of the OH content in the portion was less than 20 wt ppm away from the mean value. The thickness of the peripheral portion to be removed was between 5 and 15 mm. In the ingots having the test numbers 7 and 8, the peripheral portion was not removed despite the excessively low OH content. In the ingot no. 7 with a mean OH content of about 213 wt ppm, the peripheral portion had an OH content that was lower by about 25 wt ppm, and in the ingot no. 8 the maximum deviation of the OH content in the peripheral portion with respect to the mean OH content (determined in consideration of the OH content in the peripheral portion) was even more than 30 wt ppm.

Thereupon, the mean OH content before the second annealing process was at any rate (except for ingot no. 7) in the range between 225 and 252 wt ppm in the ingots produced according to the soot method, and in the range between 800 and 850 wt ppm in the ingots produced by direct vitrification. Except for test ingots 7 and 8, the maximum deviation from the respective mean value was less than 20 wt ppm.

The diameter of the ingots before the removal of the overdimension and before the second annealing treatment was each time 250 mm and the ingot thicknesses varied between 36 mm and 52 mm. The respective OH contents for the eight test ingots are indicated in Table 1.

Stress Birefringence

The determination of stress birefringence in the plane perpendicular to the cylindrical longitudinal axis of the ingots was each time carried out on the basis of a circular measurement portion having a diameter of 190 mm, which approximately corresponded to the outer diameter of the optical component to be produced and is outlined in FIGS. 1 and 2 by way of a broken circumferential line 7. Within said portion the amplitude of stress birefringence and the orientation of the fast axis of stress birefringence were each time measured in a uniform grid of 10 mm×10 mm. Points 6 and 6b in FIGS. 1 and 2 schematically represent individual measurement points of the 10 mm×10 mm grid (without illustration of the exact position of the measurement points).

To this end stress birefringence was determined at a wavelength of 633 nm (He—Ne laser) according to the method described in “Measurement of the Residual Birefringence Distribution in Glass Laser Disk by Transverse Zeeman Laser” (Electronics and Communications in Japan, Part 2, Vol. 74, No. 5, 1991; (English translation in Vol. 73-C-I, No. 10, 1990 pp. 652-657).

Before and after the second annealing treatment a stress birefringence of not more than 2 nm/cm was each time measured on the ingots, the refractive index distribution being so homogeneous that the difference between the maximum value and the minimum value was below 2×10⁻⁶. However, a change in the orientation of the fast axis of stress birefringence was found, as will be described in more detail hereinafter, and this is schematically shown in FIG. 2.

On the basis of the measured data, a signed dimension value “M” for stress birefringence was determined in consideration of the orientation of the fast axis of stress birefringence with the help of the following calculation formula:

$$M = \frac{1}{N} {\sum }_{i = 1}^{N} SDB ( {r}_{i} , {φ}_{i} ) \cdot {δ}_{i} \qquad ( 1 )$$

N Total number of the data points according to the 10 mm×10 mm-grid
SDB Amplitude (amount) of stress birefringence at the i^{th} data point
rᵢ Distance of the i^{th} data point from the cylindrical longitudinal axis (radius)
φᵢ Polar angle of the i^{th} data point
δᵢ =1 if at the i^{th} data point the angle of the fast axis has a predominantly tangential orientation relative to the cylindrical longitudinal axis.
   =−1 if at the i^{th} data point the angle of the fast axis has a predominantly radial orientation relative to the cylindrical longitudinal axis

Determination of the Compaction and Decompaction Behavior

For the determination of the compaction and decompaction behavior special samples having dimensions of 25 mm×25 mm×100 mm were prepared from the respective ingot material, the samples having been polished on their two opposite 25 mm×25 mm surfaces. Before and after the second annealing treatment said samples were each time exposed in an area near the sample center to pulsed UV radiation of a wavelength of 193 nm at a pulse length of 20 ns and energy densities of 35 μJ/cm². The pulse number in these irradiation tests was each time 25 billions (2.5×10¹⁰ pulses). The effect of this irradiation was measured as a relative increase or decrease in the refractive index in the irradiated region in comparison with the non-irradiated region using a commercial interferometer (Zygo GPI-XP) at a wavelength of 633 nm.

With the help of a preliminary test, suitable annealing times were determined for the re-orientation of the angle of the fast axis. The test ingots prepared according to the soot method were each annealed at a temperature of 450° C. in a nitrogen atmosphere and the change in the angular distribution after different annealing periods was determined.

The result of this preliminary test is shown in the diagram of FIG. 3. The dimension value “M” is plotted therein in the unit [nm/cm], which characterizes stress birefringence and orientation of the fast axis, versus the annealing duration “C”. Hence, with the beginning of the annealing process a re-orientation of the angular distribution of the fast axis of stress birefringence directly takes place from a rather tangential distribution towards a rather radial-symmetric distribution, but it is only after an annealing duration of about 50 hours that the degree of re-orientation becomes so great that it seems to be of technical relevance. After an annealing period of about 250 to 300 hours a zero crossing is measured, resulting in a negative dimension value “M”. This means that in this test ingot the character of the initially tangential angular distribution of the fast axis was offset due to the re-orientation during the annealing operation, and that during further annealing the character towards the radial-symmetric distribution gets more and more pronounced. This effect continues up to the longest annealing duration of this measurement series of 456 hours, and it must be assumed that the re-orientation of the angular distribution continues with even longer annealing times. However, due to the very long annealing times the above-described drawbacks regarding purity and composition of the glass samples arise, so that annealing durations of more than 30 days (720 hours) are not preferred.

Following these preliminary tests, the annealing treatment, which will be described in more detail hereinafter, was carried out on 8 test ingots.

Carrying Out the Second Annealing Treatment

The ingots were kept in a nitrogen-hydrogen atmosphere at the temperatures indicated in Table 1, column 3, for period of times indicated in column 4, and the partial pressure of the hydrogen was just set each time in such a manner that neither a depletion of hydrogen nor an enrichment in the ingots was observed. The absolute pressure of the annealing atmosphere was 10⁵ Pa each time.

After completion of the annealing treatment the annealing furnace was switched off so that the quartz glass ingots could freely cool down in the closed furnace.

Following a regrinding process the stress birefringence and the extension of the fast axis were measured again, as outlined in FIG. 2, and the above-described laser irradiation measurements were again taken for determining the compaction and decompaction behavior.

Details regarding the chemical composition of the respective test ingots and the parameters in the second annealing treatment follow from Table 1.

TABLE 1

| | | Anneal. | Anneal. | OH- | | |
|---|---|---|---|---|---|---|
| Ingot | Prod. | temp. | duration | content | Δ-OH | H₂-content |
| No. | process | [° C.] | [h] | [ppm] | [ppm] | [mol./cm³] |
| 1 | Soot | 450 | 312 | 255 | 9 | 8 × 10¹⁶ |
| 2 | Soot | 490 | 312 | 250 | 6 | 8 × 10¹⁶ |
| 3 | Soot | 490 | 528 | 253 | 8 | 8 × 10¹⁶ |
| 4 | DQ | 490 | 312 | 850 | 14 | 2 × 10¹⁷ |
| 5 | DQ | 450 | 312 | 860 | 15 | 2 × 10¹⁷ |
| 6 | DQ | 490 | 528 | 855 | 15 | 2 × 10¹⁷ |
| 7 | Soot | 490 | 528 | 250 | 25 | 5 × 10¹⁶ |
| 8 | DQ | 490 | 528 | 850 | 31 | 2 × 10¹⁷ |

The designation “soot” in the column “production process” designates a test ingot which was obtained by flame hydrolysis of SiCl₄ and OVD according to the “soot method”. The designation “DQ” stands for a test ingot which was obtained by flame hydrolysis of SiCl₄ and VAD with direct vitrification of the SiO₂ particles on the substrate.
The column Δ-OH designates the maximum deviation of the OH content from the mean value (column 5), measured before the second annealing treatment and after removal of the peripheral portion.
The column “H₂ content” designates the mean hydrogen concentration before the second annealing treatment.

Results

The results as found will be explained in more detail hereinafter with reference to FIGS. 1 to 5:

FIG. 1 is a top view on the surface of a quartz glass ingot 1 viewed in parallel with the cylindrical longitudinal axis 2. The ingot has an outer diameter of 250 mm and comprises the outer contour of the optical component to be produced, whose outer diameter is illustrated by the broken line 7, with a radial overdimension 4 of a thickness of about 30 mm and on the cylinder faces of about 4 mm. Most of the radial overdimension of about 30 mm accounts for a portion which although it belongs to the optical component to be produced is outside the optically relevant portion (the CA diameter is 190 mm). The above-explained measurements for determining the mean OH content and the maximum deviation therefrom were taken at measurement points 5 and 5a, which were uniformly distributed over the diameter.

FIG. 1, which is a schematic illustration, also shows the orientation of the fast axis of birefringence as determined by measurement of the stress birefringence at several data points 6 uniformly distributed in a 10×10 mm grid over the measurement plane. It was found that before the second annealing treatment the quartz glass ingots had a substantially tangential extension of this angle, based on the cylindrical longitudinal axis 2, as schematically shown by symbols 6 in FIG. 1.

As a rule, the measurement of the OH content at the two outer measurement points 5a of the quartz glass ingots 1 showed a deviation of more than 20 wt ppm from the mean value of the OH content, as was calculated in consideration of all of these measurement values. Therefore, before the second annealing treatment part of the overdimension 4 with a thickness ranging between 5 mm and 156 mm was removed together with the OH content that was too low (except for ingots nos. 7 and 8).

FIG. 2 is a top view on the quartz glass ingot according to FIG. 1 after the second annealing treatment. Now the fast axis of birefringence predominantly shows a rather radial extension with respect to the cylindrical longitudinal axis 2, as schematically shown by symbols 6b. After removal of the peripheral portion, as described with reference to FIG. 1, there remained, as a rule, an overdimension 4b on the outer cylindrical surface of the ingot with a thickness between 15 and 25 mm, as compared with the optically relevant contour 7 (CA diameter=190 mm) of the optical component to be produced. The overdimension on the faces of the samples was about 4 mm each time and was not changed.

In ingot no. 7, there was no substantial change in the orientation of the fast axis of birefringence due to the second annealing treatment, as can also be seen in FIG. 3.

The bar diagram in FIG. 4 shows the “dimension value “M” (in nm/cm) for the eight test ingots indicated in Table 1, the value being determined according to the above formula (1) and taking into account both the amplitude and the sign of stress birefringence. For each of the test ingots the dimension values “M” are compared before the second annealing treatment (first bar), after the second annealing treatment (second bar) and the difference of these dimension values (third bar).

It follows that in all ingots the dimension value “M” of stress birefringence before the second annealing treatment has a positive sign. This means that the stress curves in the respective test ingots are before the annealing process such that the fast axis of stress birefringence has an essentially tangential extension about the cylindrical longitudinal axis 2 of the ingot. Apart from ingot 1 and the two comparative examples (ingots 7 and 8), the dimension value “M” has a negative sign after the annealing treatment. This means that there is a rather radial orientation of the fast axis of stress birefringence. Since the difference (third bar) is negative in all cases, the angular distribution on the whole has at any rate changed from a rather tangential distribution of the angle to a rather radial distribution.

Although the ingot 1 shows a pronounced re-orientation of the angular distribution of the fast axis of stress birefringence, a reversal from the rather tangential orientation to the rather radial orientation has not been achieved yet.

This might be due to the short annealing period and the relatively low annealing temperature of 450° C. (in comparison with ingot 2). However, it must be expected that a complete reversal of the angular distribution would be achieved after a longer annealing period.

In ingots nos. 7 and 9, a re-orientation of the angular distribution was also observed, but the degree of re-orientation remains low due to the second annealing temperature, and a complete reversal is not achieved despite a long annealing duration and a high annealing temperature. It must be assumed that during the second annealing treatment the comparatively low OH content in the peripheral portion of these ingots led to stresses that impede a re-orientation of the angular extension of the fast axis of stress birefringence.

The evaluation of the range of the mean OH concentrations between about 200 wt ppm and 250 wt ppm in the respective test ingots produced according to the soot method also showed, in comparison with the ingots that were richer in OH and were produced by direct vitrification, that the re-orientation of the angular distribution (third bar; difference) gets more pronounced with a rising OH content of the quartz glass. The reason is probably that each OH group shortens the average chain length of the quartz glass structure, and the whole structure gets thus more flexible with an increasing OH content and thereby promotes a structural new orientation.

Furthermore, it was found that there is a certain relationship between the re-orientation of the angular distribution and the initial distribution thereof. The reversal of the angular distribution was all the more pronounced the less this distribution corresponded to an “ideal symmetrical distribution” before the annealing treatment. The second annealing treatment has no significant influence on the homogeneity of the refractive index. It was found that the homogeneity of the test ingots was substantially maintained.

The influence of the second annealing treatment on radiation resistance, especially on the compaction and decompaction behavior after irradiation with high-energy UV radiation, is shown in the diagram of FIG. 5 with reference to two measurement samples having dimensions of 25 mm×25 mm×100 mm. These were obtained from test ingots that had been made from the same quartz glass; they showed the same dimensions and were subjected to the same pretreatments as the test ingots no. 5 according to the above table. The one measurement sample was also subjected to the same annealing treatment as the test ingot 5.

In the diagram of FIG. 5, the wavefront distortion is plotted on the y-axis in relative units as a change in the refractive index (at a measurement wavelength of 633 nm), based on the optical path length Δ(nL)/L, versus the pulse number “P” during irradiation of the respective measurement sample.

Irradiation was carried out with UV radiation having a wavelength of 193 nm at a pulse duration of 20 ns and a pulse energy density of 35 μJ/cm². The wavefront distortion is due to the fact that the radiated planar wavefront is destroyed by spatially different refractive indices. The wavefront distortion is thus a measure of the occurrence of compaction or decompaction.

The diagram shows typical developments of the wavefront distortion at the pulse number upon irradiation of the 25×25×100 mm³ measurement samples. Curve 41 shows the development of the wavefront distortion at the pulse number in the measurement sample that was not subjected to the second annealing treatment. Curve 42 shows these developments in the measurement sample that was subjected to the second annealing treatment as test ingot 5.

In curve 41 a reduction of the wavefront distortion, i.e. decompaction, is observed with an increasing pulse number. This reduction continuously increases up to the maximum pulse number of 2.5×10¹⁰ pulses. Curve 42 shows a typical extension of the wavefront distortion with pulse number “P” in a measurement sample that was subjected to a second annealing treatment in the sense of the invention. After an initial low lift of about 35 ppb towards compaction a substantially uniform wavefront distortion is observed up to the maximum pulse number, but no decompaction as in the sample according to curve 41.

1. A method for producing an optical component for transmitting ultraviolet radiation of a wavelength of 250 nm and shorter, wherein the component is made from a cylindrical quartz glass blank having a mean OH content of more than 50 wt ppm, said method comprising: subjecting the quartz glass blank to a first annealing treatment so as to reduce stress birefringence therein, and subjecting the quartz glass blank to a second annealing treatment which comprises heating up and holding the quartz glass blank at a low annealing temperature ranging from 350° C. to 800° C. and for an annealing period of more than 1 hour, wherein the quartz glass blank has a deviation from the mean OH content in a direction perpendicular to the cylindrical longitudinal axis that is not more than 20 wt ppm.

2. The method according to claim 1, wherein the annealing period is at least 50 hours.

3. The method according to claim 1, wherein the annealing period is not more than 720 hours.

4. The method according to claim 1, wherein the quartz glass blank is annealed in a hydrogen containing atmosphere.

5. The method according to claim 1, wherein the quartz glass blank is annealed at a pressure between 10⁵ and 10⁶ Pa.

6. The method according to claim 1, wherein the second annealing treatment comprises holding at a temperature of at least 500° C., the quartz glass blank has a mean hydrogen content, and the first and second annealing treatments do not change the hydrogen content of the quartz glass blank by more than +/−20% relative to an initial hydrogen content thereof.

7. The method according to claim 1, wherein the quartz glass blank has an over-dimensioned outer contour including an overdimension of the optical component to be produced, and wherein at least part of the overdimension is removed between the first and the second annealing treatment.

8. The method according to claim 1, wherein prior to the second annealing treatment the quartz glass blank has an over-dimensioned outer contour including an overdimension of the optical component to be produced, and the overdimension of the cylinder faces ranges from 1 mm to 5 mm.

9. The method according to claim 1, wherein the mean OH content of the quartz glass blank prior to the second annealing treatment is at least 450 wt ppm.

10. The method according to claim 1, wherein the quartz glass blank has a mean hydrogen concentration after the first second annealing treatment that is at least 3×10¹⁶ molecules/cm³.
